(19) United States
(12) Patent Application Publication
(10) Pub. No.: US 2016/0152884 A1
(43) Pub. Date: Jun. 2, 2016

(54) ACID PRECURSOR IN DIVALENT BRINES FOR CLEANING UP WATER-BASED FILTER CAKES

(71) Applicant: M-I L.L.C., Houston, TX (US)

(72) Inventors: Raymond David Ravitz, Houston, TX (US); Mark R. Luyster, Houston, TX (US); Clotaire-Marie Eyaa Allogo, Sugar Land, TX (US)

(21) Appl. No.: 14/901,106

(22) PCT Filed: Jul. 10, 2014
(86) PCT No.: PCT/US14/46182

§ 371 Date: Dec. 28, 2015

Related U.S. Application Data
(60) Provisional application No. 61/844,778, filed on Jul. 10, 2013.

(51) Int. Cl. C09K 8/52

(52) U.S. Cl. CPC C09K 8/52; C09K 2208/26

(57) ABSTRACT

A method may include circulating a breaker fluid into a wellbore, where the breaker fluid includes a base fluid of divalent brine having an amount of free water therein; a primary breaker; and a secondary breaker present in an amount less than the primary breaker, where the primary breaker is either a hydrolysable ester of a carboxylic acid or an iminodiacetic acid, and the secondary breaker is the other of the hydrolysable ester of a carboxylic acid or an iminodiacetic acid.

This application claims the benefit of U.S. Provisional Application No. 61/844,778 filed on Jul. 10, 2013, incorporated by reference herein in its entirety.

### BACKGROUND

During the drilling of a wellbore, various fluids are typically used in the well for a variety of functions. The fluids may be circulated through a drill pipe and drill bit into the wellbore, and then may subsequently flow upward through wellbore to the surface. During this circulation, the drilling fluid may act to remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the subterranean formation by providing sufficient hydrostatic pressure to prevent the ingress of formation fluids into the wellbore, to cool and lubricate the drill string and bit, and/or to maximize penetration rate.

One way of protecting the formation is by forming a filter cake on the surface of the subterranean formation. Filter cakes are formed when particles suspended in a wellbore fluid coat and plug the pores in the subterranean formation such that the filter cake prevents or reduce both the loss of fluids into the formation and the influx of fluids present in the formation. A number of ways of forming filter cakes are known in the art, including the use of bridging particles, cuttings created by the drilling process, polymeric additives, and precipitates. Fluid loss pills may also be used where a viscous pill comprising a polymer may be used to reduce the rate of loss of a wellbore fluid to the formation through its viscosity

Upon completion of drilling, the filter cake and/or fluid loss pill may stabilize the wellbore during subsequent completion operations such as placement of a gravel pack in the wellbore. Additionally, during completion operations, when fluid loss is suspected, a fluid loss pill of natural polymers and/or bridging agents may be spotted into to reduce or prevent such fluid loss by injection of other completion fluids behind the fluid loss pill to a position within the wellbore which is immediately above a portion of the formation where fluid loss is suspected. Injection of fluids into the wellbore is then stopped, and fluid loss will then move the pill toward the fluid loss location.

After any completion operations have been accomplished, removal of filter cake (formed during drilling and/or completion) remaining on the sidewalls of the wellbore may be necessary. Although filter cake formation and use of fluid loss pills are essential to drilling and completion operations, these barriers can be a significant impediment to the production of hydrocarbon or other fluids from the well, or to the injection of water and/or gas, if, for example, the rock formation is still plugged by the barrier. Because filter cake is compact, it often adheres strongly to the formation and may not be readily or completely flushed out of the formation by fluid action alone.

Efficiency of clean-up and completion are known issues with most wells, and especially in open-hole horizontal or high angle well completions. The productivity of a well is somewhat dependent on effectively and efficiently removing the filter cake in a manner that reduces the potential of water blocking, plugging, or otherwise damaging the natural flow channels of the formation, as well as those of the completion assembly.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method that include circulating a breaker fluid into a wellbore, where the breaker fluid includes a base fluid of divalent brine having an amount of free water therein; a primary breaker; and a secondary breaker present in an amount less than the primary breaker, where the primary breaker is either a hydrolysable ester of a carboxylic acid or an iminodiacetic acid, and the secondary breaker is the other of the hydrolysable ester of a carboxylic acid or an iminodiacetic acid.

In another aspect, embodiments disclosed herein relate to a method that includes circulating a breaker fluid into a wellbore, where the breaker fluid includes a base fluid of divalent brine; a hydrolysable ester of a carboxylic acid in an amount ranging from 10 to 50 volume percent; and an iminodiacetic acid in an amount ranging up to 10 volume percent, wherein the breaker fluid has a free water content of at least 25 volume percent.

In yet another aspect, embodiments disclosed herein relate to a method that includes circulating a breaker fluid into a wellbore, where the breaker fluid includes a base fluid of divalent brine; an acid precursor in an amount ranging up to 10 volume percent; and an iminodiacetic acid in an amount ranging from 10 to 40 volume percent, wherein the breaker fluid has a free water content of at least 25 volume percent.

Other aspects of the claimed subject matter will be apparent from the following description and the appended claims.

### BRIEF DESCRIPTION OF DRAWINGS

FIG. 1 depicts test results for fluids in accordance with embodiments of the present disclosure.

FIGS. 2 and 3 depict return flow test results for fluids in accordance with embodiments of the present disclosure.

### DETAILED DESCRIPTION

In one aspect, embodiments disclosed herein are generally directed to chemical breaker and displacement fluids that are useful in the drilling, completing, and working over of subterranean wells, preferably oil and gas wells. In another aspect, embodiments disclosed herein are generally directed to the formulation of a breaker fluid. Specifically, embodiments may contain a hydrolysable ester of a carboxylic acid, a chelant, and a divalent brine.

Breaker fluids including a hydrolysable ester of carboxylic acid are effective for removing the filtercakes formed by oil based and water-based drilling muds in a wellbore. The hydrolysable esters are selected so that upon hydrolysis (which may occur in situ upon emplacement of the fluid in the wellbore) an organic acid is released so that it may react with filter cake components, thereby breaking the filter cake. One possibility of using hydrolysable ester of carboxylic acid in the breaker fluid is that when the breaker is used in a divalent brine, calcium formate precipitation may occur, as well as other precipitants such as those discussed in SPE 164472, SPE164050, and SPE1781, which are incorporated by reference in their entirety.

While a chelant may theoretically sequester the calcium (as well as other cations), many chelants cannot be dissolved (at concentrations for effective sequestering) in divalent brine-based breaker fluids, at the conditions in which the breaker fluids is used to break the filter cake. However, embodiments of the present disclosure relate to the combination of a hydrolysable ester of carboxylic acid with a class of iminodiacetic acid-type chelants in a divalent brine. Specifically, such combination (hydrolysable ester and iminodiacetic acid in a divalent brine) allows for a solubilized chelant that can sequester calcium ions (from the brine or dissolved calcium carbonate) or other ions such as iron, magnesium, etc., thereby preventing or at least mitigating precipitation of calcium formate (or other carboxylic acids such as acetate, citrate, etc.) that is otherwise not achievable with other chelant classes in a divalent brine.

Further, one or more embodiments of the present disclosure may allow for the use of the hydrolysable ester as the primary breaking component (to break the filter cake through generation of acid), with the iminodiacetic acid as a sequesterer, or the use of the iminodiacetic acid as the primary breaking component (to break the filter cake through chelation of calcium from calcium carbonate bridging agents), with the hydrolysable ester as an acidic buffering agent. In the first scenario, the hydrolysable ester may be present in an amount ranging from about 10 to 50 volume percent of the breaker fluid, and from about 20 to 40 volume percent in one or more particular embodiments, while the iminodiacetic acid may be present in an amount ranging from 1 to 10 volume percent, or 1 to 5 volume percent in more particular embodiments. In the second scenario, the iminodiacetic acid may be present in an amount ranging from 10 to 40 volume percent, and from 15 to 35 volume percent in one or more particular embodiments, while the hydrolysable ester may be present in an amount ranging from 1 to 10 volume percent or 1 to 5 volume percent in more particular embodiment. The amount of each component may depend on which is selected as the primary breaker (and which are selected for a secondary role to buffer the primary component) so that the primary component continues to operate in its filter cake braking function.

As mentioned above, the breaker fluids of the present disclosure may include at least one iminodiacetic acid or a salt thereof, which may be represented by the formula:

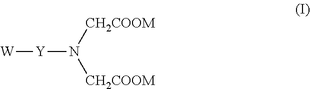

wherein the M groups each independently represents a hydrogen atom, an alkali metal atom, an ammonium group or a substituted ammonium group; Y represents a divalent alkyl group having from 1 to 7 carbon atoms and the divalent alkyl group may be substituted by a hydroxyl group or a COOM group wherein M represents a hydrogen atom, an alkali metal atom, an ammonium group or a substituted ammonium group; and W represents a hydrogen atom, a hydroxyl group or a COOM group wherein M represents a hydrogen atom, an alkali metal atom, an ammonium group or a substituted ammonium group. Use of such iminodiacetic acids (salts) is described in U.S. Patent Application Ser. No. 60/890,586, which is assigned to the present assignee and herein incorporated by reference in its entirety.

In one or more embodiments, the iminodiacetic acid may be represented by the above formula I, wherein the M groups each independently represents a hydrogen atom, an alkali metal atom, an ammonium group or a substituted ammonium group; Y represents a divalent alkyl group having from 1 to 7 carbon atoms and the divalent alkyl group may be substituted by a hydroxyl group or a COOM group wherein M represents a hydrogen atom, an alkali metal atom, an ammonium group or a substituted ammonium group; and W represents a COOM group, wherein M represents a hydrogen atom, an alkali metal atom, an ammonium group or a substituted ammonium group.

In one or more embodiments, the iminodiacetic acid may be represented by the above formula I, wherein the M groups each independently represents a hydrogen atom, an alkali metal atom, an ammonium group or a substituted ammonium group, wherein Y represents a divalent alkyl group having from 2 to 7 carbon atoms and the divalent alkyl group may be substituted by a COOM group (wherein the M group each independently represents a hydrogen atom, an alkali metal atom, an ammonium group or a substituted ammonium group); and W represents a hydroxyl group or a COOM group (wherein the M groups each independently represent a hydrogen atom, an alkali metal atom, an ammonium group or a substituted ammonium group).

In the iminodiacetic acids (salts) represented by formula I of the present disclosure, the —COOM group is a carboxyl group or an alkali metal salt or ammonium salt thereof, in one or more embodiments, and the alkali metal atom may be sodium or potassium, specifically, sodium, in particular embodiments. Examples of groups represented by Y in formula I are set forth below.

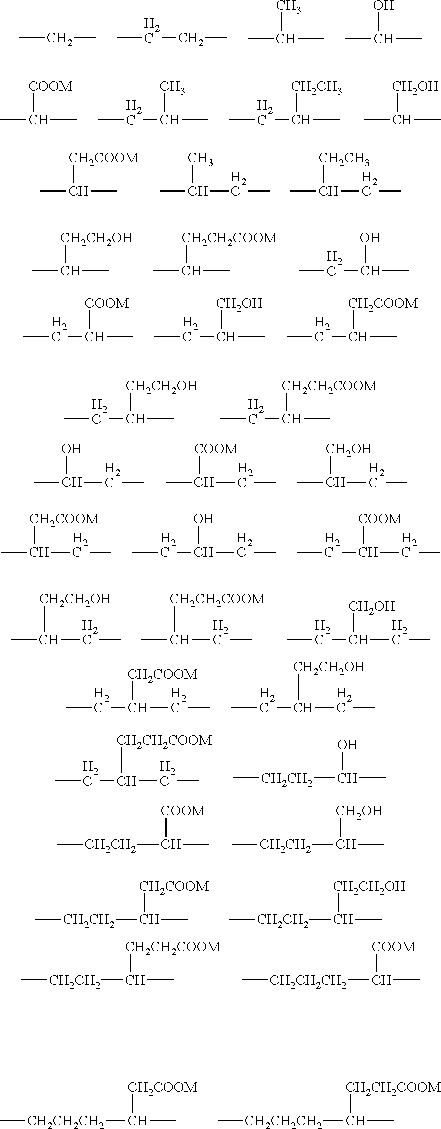

Examples of iminodiacetic acids (salts) include α-alanine-N,N-diacetic acid (salt), β-alanine-N,N-diacetic acid (salt), aspartic acid-N,N-diacetic acid (salt), glutamic acid-N,N-diacetic acid (salt), serine-N,N-diacetic acid (salt), ethanolamine-N,N-diacetic acid (salt), iminodiacetic acid (salt) and nitrilotriacetic acid (salt), among which glutamic acid-N,N-diacetic acid (salt) is particularly used in one or more embodiments of the present disclosure. These iminodiacetic acids (salts) are compounds having a chelating ability and are considered to enhance the degradation, dispersion, dissolution or clean-up of the filter cake as a result of complexing with any free calcium ion due to a chelating action, and possess greater compatibility and solubility in a large range of base fluids, particularly in divalent brines. The well bore fluids of the present disclosure may contain one or more of these iminodiacetic acids (salts).

The present fluids may also include a hydrolysable ester, which may hydrolyze to release an organic (or inorganic) acid, including, for example, hydrolyzable esters of a C₁ to C₆ carboxylic acid and/or a C₂ to C₃₀ mono- or poly-alcohol, including alkyl orthoesters. If, for example, a particular hydrolyzable ester of a C₁ to C₆ carboxylic acid and/or a C₂ to C₃₀ poly alcohol were found to be above its melting point at or around the temperature desired for applying the same, then it would be readily understood by one skilled in the art that a longer chain carboxylic acid and/or a longer chain mono- or poly-alcohol could be found that would be a solid in this same temperature range. In addition to these hydrolysable carboxylic esters, hydrolysable phosphonic or sulfonic esters could be utilized, such as, for example, R¹H₂PO₃, R¹R²HPO₃, R¹R²R³PO₃, R¹HSO₃, R¹R²SO₃, R¹H₂PO₄, R¹R²HPO₄, R¹R²R³PO₄, R¹HSO₄, R¹R²SO₄, where R¹, R², R³ are C₂ to C₃₀ alkyl-, aryl-, arylalkyl-, or alkylaryl-groups. In addition to the said organic acids and hydrolysable esters, hydrolysable anhydrides, amides, and nitriles of said carboxylic moieties or carboxylic esters and be used. One example of a suitable hydrolysable ester of carboxylic acid is available from M-I, L.L.C. (Houston, Tex.) under the name D-STRUCTOR.

A hydrolysable ester (or other similar compounds) includes compounds which will release acid upon length of time. In particular, compounds that hydrolyze to form acids in situ may be utilized as an organic acid. Such delayed source of acidity may be provided, for example, by hydrolysis of an ester. Illustrative examples of such organic acids that provide for a delayed acid release include hydrolyzable anhydrides of carboxylic acids, hydrolyzable esters of carboxylic acids; hydrolyzable esters of phosphonic acid, hydrolyzable esters of sulfonic acid and other similar hydrolyzable compounds that should be well known to those skilled in the art.

Suitable esters may include carboxylic acid esters so that the time to achieve hydrolysis is predetermined on the known downhole conditions, such as temperature and pH. In a particular embodiment, the delayed pH component may include a formic or acetic acid ester of a C₂ to C₃₀ alcohol, which may be mono- or polyhydric. Other esters that may find use in activating the oxidative breaker of the present disclosure include those releasing C₁ to C₆ carboxylic acids, including hydroxycarboxylic acids formed by the hydrolysis of lactones). In another embodiment, a hydrolyzable ester of a C₁ to C₆ carboxylic acid and/or a C₂ to C₃₀ poly alcohol, including alkyl orthoesters, may be used.

As mentioned above, the combination of hydrolysable ester and iminodiacetic acid has particularly synergistic effect, when used in combination with divalent brines. In one or more embodiments, the hydrolysable ester and iminodiacetic acid are dissolved in a divalent brine that is used as the base fluid for the breaker fluid. In particular embodiments, the divalent brine forms the continuous phase of the breaker fluid. However, the present disclosure is not so limited. Rather, it is also within the scope of the present disclosure that the divalent brine may be in the drilling fluid that forms the filter cake removed by the hydrolysable ester and iminodiacetic acid combination. Such divalent brines may include calcium, magnesium, and/or zinc brines of various halides, such as chlorides and bromides. Thus, densities of the divalent brines may be at least 10 ppg in one or more embodiments, or at least 11 ppg, 12 ppg, 12.5 ppg, 13 ppg, 13.5 ppg, 14 ppg, or 14.5 ppg in more particular embodiments. When selecting a brine based on the density needs (depending on the needs of the particular wellbore), the selection may also take into consideration the free water content that results from weighting up to the desired density. Specifically, in one or more embodiments, the fluid may be formulated to ensure a free water content of at least about 10 percent, 15 percent, 20 percent, 25 percent, or 30 percent. The present inventors have found that incorporating a sufficient free water content may result in an advantageous clean-up of the filter cake and residue. Further, in one or more embodiments, the pH of the breaker fluid may range from 2 to 5, or at least 2.5, 3, 3.5, or 4 in other embodiments.

It should be appreciated that the amount of delay between the time when a breaker fluid according to the present invention is introduced to a well and the time when the fluids have had the desired effect of breaking/degrading/dispersing the filter cake may depend on several variables. One of skill in the art should appreciate that factors such as the downhole temperature, concentration of the components in the breaker fluid, pH, amount of available water, filter cake composition, etc. may all have an impact. For example downhole temperatures can vary considerably from 100° F. to over 400° F. depending upon the formation geology and downhole environment. However, one of skill in the art via trial and error testing in the lab should easily be able to determine and thus correlate downhole temperature and the time of efficacy of for a given formulation of the breaker fluids disclosed herein. With such information one can predetermine the time period necessary to shut-in a well given a specific downhole temperature and a specific formulation of the breaker fluid.

However it should also be appreciated that the breaker fluid formulation itself and thus the fluid's chemical properties may be varied so as to allow for a desirable and controllable amount of delay prior to the breaking of invert emulsion filter cake for a particular application. In one embodiment, the amount of delay for an invert emulsion filter cake to be broken with a water-based displacement fluid according to the present invention may be greater than 1 hour. In various other embodiments, the amount of delay for an invert emulsion filter cake to be broken with a water-based displacement fluid according to the present invention may be greater than 3 hours, 5 hours, or 10 hours. Thus the formulation of the fluid can be varied to achieve a predetermined break time and downhole temperature.

One of skill in the art should appreciate that in one embodiment, the amount of delay for a water based filter cake to be broken with a water based breaker fluid may be greater than 15 hours. In various other embodiments, the amount of delay for a water-based filter cake to be broken with a water based breaker fluid may be greater than 24 hours, 48 hours, or 72 hours. In second embodiment, the amount of delay for an invert emulsion filter cake to be broken with a water-based breaker fluid may be greater than 15 hours. In various other embodiments, the amount of delay for an invert emulsion filter cake to be broken with a water based breaker fluid may be greater than 24 hours, 48 hours, or 72 hours.

Breaker fluids of embodiments of this disclosure be emplaced in the wellbore using conventional techniques known in the art, and may be used in drilling, completion, workover operations, etc. Additionally, one skilled in the art would recognize that such wellbore fluids may be prepared with a large variety of formulations. Specific formulations may depend on the stage in which the fluid is being used, for example, depending on the depth and/or the composition of the formation. The breaker fluids described above may be adapted to provide improved breaker fluids under conditions of high temperature and pressure, such as those encountered in deep wells, where high densities are required. Breaker fluids may find particular use when the filter cake to be broken and/or the fluid present in the well contains a divalent brine for fluid compatibility. Further, one skilled in the art would also appreciate that other additives known in the art may be added to the breaker fluids of the present disclosure without departing from the scope of the present disclosure.

The types of filter cakes that the present breaker fluids may break include those formed from oil-based or water-based drilling fluids. That is, the filter cake may be either an oil-based filter cake (such as an invert emulsion filter cake produced from a fluid in which oil is the external or continuous phase) or a water-based (such as an aqueous filter cake in which water or another aqueous fluid is the continuous phase). It is also within the scope of the present disclosure that filter cakes may also be produced with direct emulsions (oil-in-water), or other fluid types.

As described above, the breaker fluid may be circulated in the wellbore during or after the performance of at least one completion operation. In some embodiments, the breaker fluid may be pumped or spotted into the wellbore without circulation during or after the performance of at least one completion operation. In other embodiments, the breaker fluid may be circulated, spotted, or pumped either after a completion operation or after production of formation fluids has commenced to destroy the integrity of and clean up residual drilling fluids remaining inside casing or liners.

Generally, a well is often “completed” to allow for the flow of hydrocarbons out of the formation and up to the surface. As used herein, completion processes may include one or more of the strengthening the well hole with casing, evaluating the pressure and temperature of the formation, and installing the proper completion equipment to ensure an efficient flow of hydrocarbons out of the well or in the case of an injector well, to allow for the injection of gas or water. Completion operations, as used herein, may specifically include open hole completions, conventional perforated completions, sand exclusion completions, permanent completions, multiple zone completions, and drainhole completions, as known in the art. A completed wellbore may contain at least one of a slotted liner, a predrilled liner, a wire wrapped screen, an expandable screen, premium mesh screens, a sand screen filter, a open hole gravel pack, or casing.

Breaker fluids as disclosed herein may also be used in a cased hole to remove any drilling fluid left in the hole during any drilling and/or displacement processes. Well casing may consist of a series of metal tubes installed in the freshly drilled hole. Casing serves to strengthen the sides of the well hole, ensure that no oil or natural gas seeps out of the well hole as it is brought to the surface, and to keep other fluids or gases from seeping into the formation through the well. Thus, during displacement operations, typically, when switching from drilling with an oil-based mud to a water-based mud (or vice-versa), the fluid in the wellbore is displaced with a different fluid. For example, an oil-based mud may be displaced by another oil-based displacement to clean the wellbore. The oil-based displacement fluid may be followed with a water-based displacement fluid prior to beginning drilling or production. Conversely, when drilling with a water-based mud, prior to production, the water-based mud may be displacement water-based displacement, followed with an oil-based displacement fluid. Further, one skilled in the art would appreciate that additional displacement fluids or pills, such as viscous pills, may be used in such displacement or cleaning operations as well, as known in the art.

Another embodiment of the present disclosure involves a method of cleaning up a well bore drilled with an oil based drilling fluid. In one such illustrative embodiment, the method involves circulating a breaker fluid disclosed herein in a wellbore, and then shutting in the well for a predetermined amount of time, typically while production tubing and flow line are run, and/or the well is lined-up to the designated production facility, to allow penetration and fragmentation of the filter cake to take place. Subsequently the designated well is brought on-line whereby the initial clean-up of the well is initiated and fluids from the flowline, production tubing and finally the open hole flow to the surface thus transporting the now spent breaker fluid to the surface.

The fluids disclosed herein may also be used in a wellbore including a barefoot completion or a screened completion, for example. After a hole is drilled to a desired diameter (or under-reamed to widen the diameter of the hole), the drilling string may be removed and replaced with a completion assembly which includes in some cases a desired sand control screen. Alternatively, an expandable tubular sand screen may be run into the open hole and expanded in place or a gravel pack may be pumped in the open hole. Breaker fluids may then be placed in the well, and the well is then shut in to allow penetration and fragmentation of the filter cake to take place. Upon fragmentation of the filter cake, the fluids can be easily produced from the well bore upon initiation of production and thus the residual filtercake, in part or in whole, is produced out of the well bore. Alternatively, a wash fluid (different from the breaker fluid) may be circulated through the wellbore prior to commencing production.

However, the breaker fluids disclosed herein may also be used in various embodiments as a displacement fluid and/or a wash fluid. As used herein, a displacement fluid is typically used to physically push another fluid out of the wellbore, and a wash fluid typically contains a surfactant and may be used to physically and chemically remove drilling fluid reside from downhole tubulars. When also used as a displacement fluid, the breaker fluids of the present disclosure may act effectively push or displace the drilling fluid. When also used as a wash fluid, the breaker fluids may assist in physically and/or chemically removing the filter cake, in part or in whole, once the filter cake has been disaggregated by the breaker system.

Further, in one or more embodiments, the present fluids may be incorporated into gravel packing carrier fluids, which is described, for example, in U.S. Pat. No. 6,631,764, which is herein incorporated by reference in its entirety. Breaker fluids are typically used in cleaning the filtercake from a wellbore that has been drilled with either a water-based drilling mud or an invert emulsion based drilling mud. Breaker fluid are typically circulated into the wellbore, contacting the filter cake and any residual mud present downhole, may be allowed to remain in the downhole environment until such time as the well is brought into production. The breaker fluids may also be circulated in a wellbore that is to be used as an injection well to serve the same purpose (i.e. remove the residual mud and filter cake) prior to the well being used for injection of materials (such as water surfactants, carbon dioxide, natural gas, etc. . . . ) into the subterranean formation. Thus, the fluids disclosed herein may be designed to form two phases, an oil phase and a water phase, following dissolution of the filtercake which can easily produced from the wellbore upon initiation of production. Regardless of the fluid used to conduct the drilling (or under-reaming) operation, the fluids disclosed herein may effectively degrade the filtercake and substantially remove the residual drilling fluid from the wellbore upon initiation of production.

Further, it is also within the scope of the present disclosure that the present breaker components may be incorporated into a carrier fluid for gravel packing. Specific techniques and conditions for pumping a gravel pack composition into a well are known to persons skilled in this field. The conditions which can be used for gravel-packing in the present invention include pressures that are above fracturing pressure, particularly in conjunction with the Alternate Path Technique, known for instance from U.S. Pat. No. 4,945,991, and according to which perforated shunts are used to provide additional pathways for the gravel pack slurry. Furthermore, certain oil based gravel pack compositions of the present invention with relatively low volume internal phases (e.g., discontinuous phases) can be used with alpha- and beta-wave packing mechanisms similar to water packing.

Further, a wellbore contains at least one aperture, which provides a fluid flow path between the wellbore and an adjacent subterranean formation. In an open hole completed well, the wellbore's open end, that is abutted to the open hole, may be the at least one aperture. Alternatively, the aperture can comprise one or more perforations in the well casing. At least a part of the formation adjacent to the aperture has a filter cake coated on it, formed by drilling the wellbore with either a water- or oil-based wellbore fluid that deposits on the formation during drilling operations and comprises residues of the drilling fluid. The filter cake may also comprise drill solids, bridging/weighting agents, surfactants, fluid loss control agents, and viscosifying agents, etc. that are residues left by the drilling fluid.

### Examples

The present examples tested two breaker formulations to assess their potential to degrade a residual drill-in reservoir fluid filtercake while providing a delay to pull out of hole with a washpipe. The first option is a combination of D-STRUCTOR, which is a hydrolysable ester (acid precursor), and D-SOVLVER HD, a protonated iminodiacetic acid chelant, both of which are commercially available from MI SWACO (Houston, Tex.). Formulations 2 and 3 utilize varying concentrations to promote lower corrosion potential and delay. The DSTRUCTOR produces organic acid with time, temperature, and contact with water, which can attack the filter cake. It can also function as an acidic buffer which promotes a more complete degradation of the residual starch while the D-SOVLVER HD complexes the calcium, magnesium, etc. (i.e., cations) from the residual calcium carbonate, in Formulation 3.

To fully assess the two breaker systems breakthrough time or delay as well as the relative return to flow as production, a total of 3 HTHP cells were assembled. A reservoir drill in system which was dynamically aged for 16 hours (Table 1) was used to deposit filtercakes at 180° F. using a FAO-05 aloxite disk for 16 hours. One HTHP cell was used for a control. No breaker system was applied and the percent of return to flow was measured in an arbitrary production direction. DI-TROL is a starch, DI-BALANCE is highly reactive magnesium oxide (discussed in SPE 68965), and SAFE-CARB is sized calcium carbonate, all of which are available from MI SWACO (Houston, Tex.).

TABLE 1
13.3 ppg RDF Formulation

| Products | Amount | |
|---|---|---|
| 14.2 ppg CaBr2 | 0.49 | bbl/bb l |
| 11.6 ppg CaCl2 | 0.49 | bbl/bbl |
| Dry CaCl2 | 10.1 | ppb |
| DI-TROL | 8 | ppb |
| DI-BALANCE | 0.25 | ppb |
| SAFE-CARB 2 | 2 | ppb |
| SAFE-CARB 10 | 3 | ppb |
| SAFE-CARB 20 | 30 | ppb |
| SAFE-CARB 40 | 5 | ppb |

The fluid loss (filtrate volume) was captured for future reference for each of the three filtercakes shown on Table 2.

TABLE 2
Fluid Loss of Dynamic Aged 13.3 lb./gal.
RDF at 180° F. and 500 psi.

| | Fluid Loss (mL) | | |
|---|---|---|---|
| Time (min) | HPHT #1 | HPHT #2 | HPHT #3 |
| 0 | 2.0 | 2.2 | 2.4 |
| (Spurt Loss) | | | |
| 1 | 2.4 | 2.4 | 2.6 |
| 2 | 2.6 | 2.5 | 2.8 |
| 4 | 2.8 | 2.7 | 3.0 |
| 9 | 3.0 | 3.0 | 3.4 |
| 16 | 3.4 | 3.4 | 3.7 |
| 25 | 3.7 | 3.8 | 4.0 |
| 30 | 4.0 | 4.0 | 4.2 |
| 36 | 4.2 | 4.2 | 4.6 |

The proposed breaker systems are shown in Table 3 and are summarized below:

HTHP cell #1: Formulation 0 (the control test). Thus only brine was poured into the HTHP cell with the filtercake and 20/40 gravel. Fluid loss was measured during the total 7 day static fluid loss period, table 4.

HTHP cell #2: Formulation 2 which include 30% v/v D-STRUCTOR plus 2.5% v/v D-SOVLVER HD on the filtercake and the 20/40 gravel. The gravel pre-soaked with 13.0 ppg CaCl2/CaBr2 and on the top poured the BREAKDOWN as a procedure of the post-spot Breaker operation.

HTHP cell #3: Formulation 3 included 30% v/v D-SOVLVER HD plus 2.5% D-STRUCTOR with the filtercake and the 20/40 gravel. This simulated a post-spot.

TABLE 3
Formulations of the Breaker Systems

| | Formulation | | Formulation | | Formulation | |
|---|---|---|---|---|---|---|
| Products | #1 (Control) | | #2 | | #3 | |
| 14.2 ppg CaBr₂ | 0.49 | bbl/bb l | 0.675 | bbl/bbl | 0.675 | bbl/bbl |
| 11.6 ppg CaCl₂ | 0.49 | bbl/bbl | | | | |
| Dry CaCl2 | 10.1 | ppb | | | | |
| D-STRUCTOR | | | 0.300 | bbl/bbl | 0.025 | bbl/bbl |
| D-SOVLVER HD | | | 0.025 | bbl/bbl | 0.300 | bbl/bbl |
| Density | 13.0 | ppg | 13.3 | ppg | 13.3 | ppg |

The breakthrough time is measured from the time beginning with addition of the breaker to the HTHP cell and ending when a steady stream of effluent is evident thru the stem located on the bottom of the HTHP cell. Thus, the filtercake partially degrades and the fluid flows uncontrolled due to the pressure differential between the inside/top of the cell and the atmosphere. The cumulative volume of filtrate is collected during this period and is shown in Table 4. Breaker Formulations 2 and 3 exhibited more than six hours before breakthrough was evident, however the time is less than 12 hours as the cells were shut-in after six hours. Thus these values may be used to calculate the delay required after pulling the wash pipe and closing the formation insulation valve in lieu of losses.

TABLE 4
Filtrate Collected during Breaker Test
at 500 psi differential and 180° F.

| Time | Formulation | Formulation | Formulation |
|---|---|---|---|
| (hours) | #1 | #2 | #3 |
| 0 | 0 | 0 | 0 |
| 2 | | | |
| 3 | | | |
| 4 | | | |
| 6 | 1.4 | 3.2 | 2.4 |
| 12 | | Broke (12 cc) | 3.2 |
| 22 | | | |
| 26 | | | |
| 28 | 4.4 | | 7.4 |
| 29 | 4.6 | | 7.6 |
| 30 | 4.8 | | 7.8 |
| 46 | 5.4 | | Broke (14.2 cc) |
| 48 | 6.4 | | |
| 71 | 10.2 | | |
| 77 | 10.8 | | |

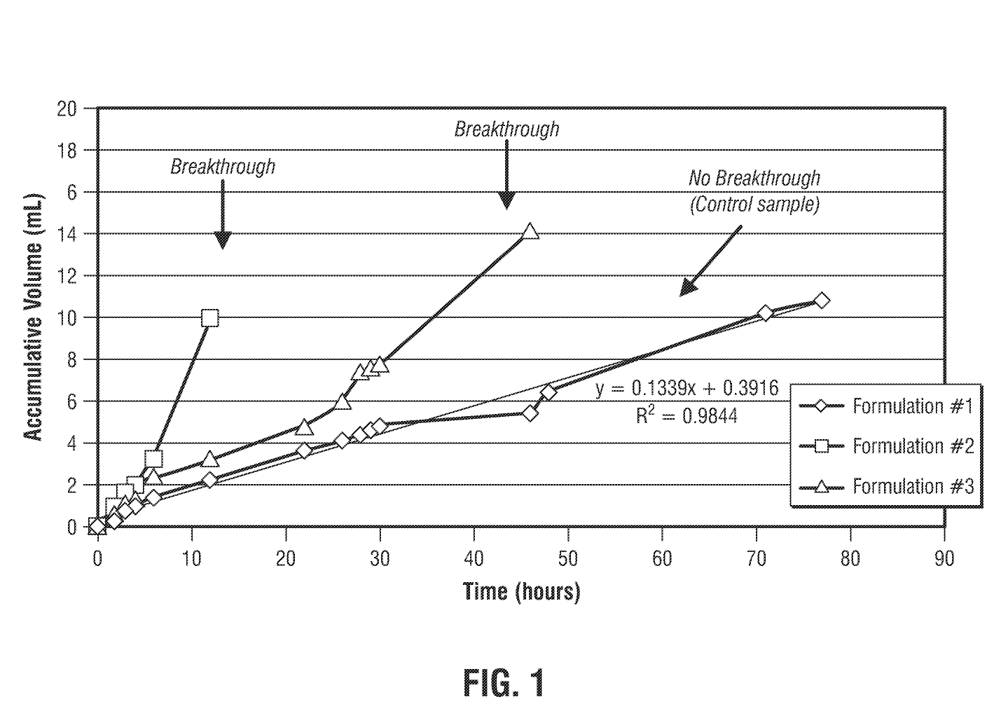

FIG. 1 shows each breaker system exhibited a steady fluid loss during the first 6 hours which is indicative of consistency in combination with the particular reservoir drill-in fluid residual filtercake. However after 12 hours, Formulation 2 exhibited breakthrough as noted by a steady stream exiting the HTHP cell and the precipitous slope. Formulation 3 exhibited 30 hours of laboratory delay. After breakthrough the pressure in each HTHP cell was decreased to 50 psi.

To test return to flow, the control or reference flow rate was measured using Formulation 0, which is an HTHP cell with a saturated FAO-05 aloxite disk with LVT-200 and 60 grams of 20/40 gravel saturated with 13.0 ppg CaCl₂/CaBr₂. (Table 5). Flow rates are recorded using LVT-200.

For HTHP cell #2 and #3 a total of 80 ml of breaker system was added to cell and after breakthrough time the valve bottom and top valve of the HTHP were closed and pressure was decreased to 50 psi and left for the six remaining days. After 7 days of breaker exposure, all cells were open.

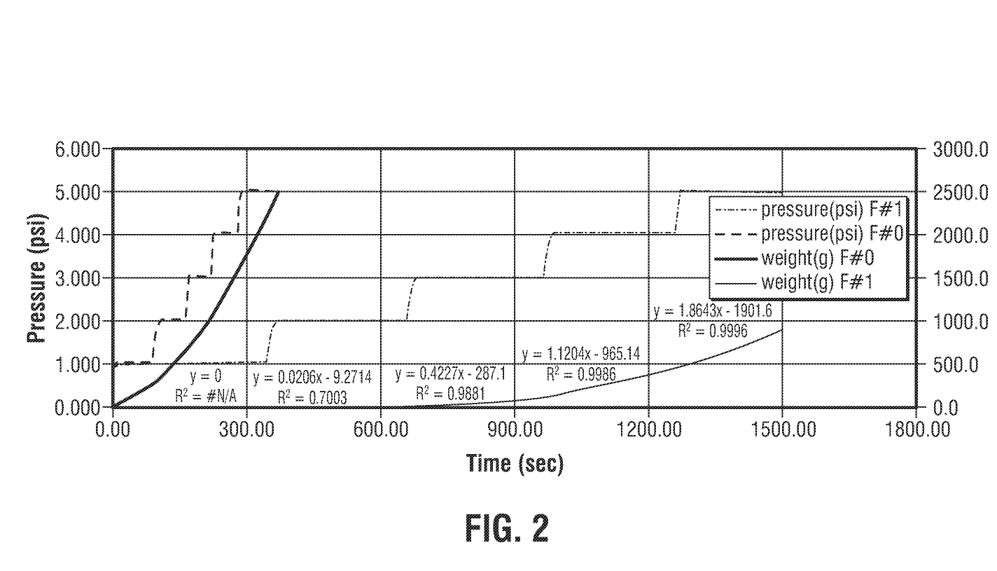

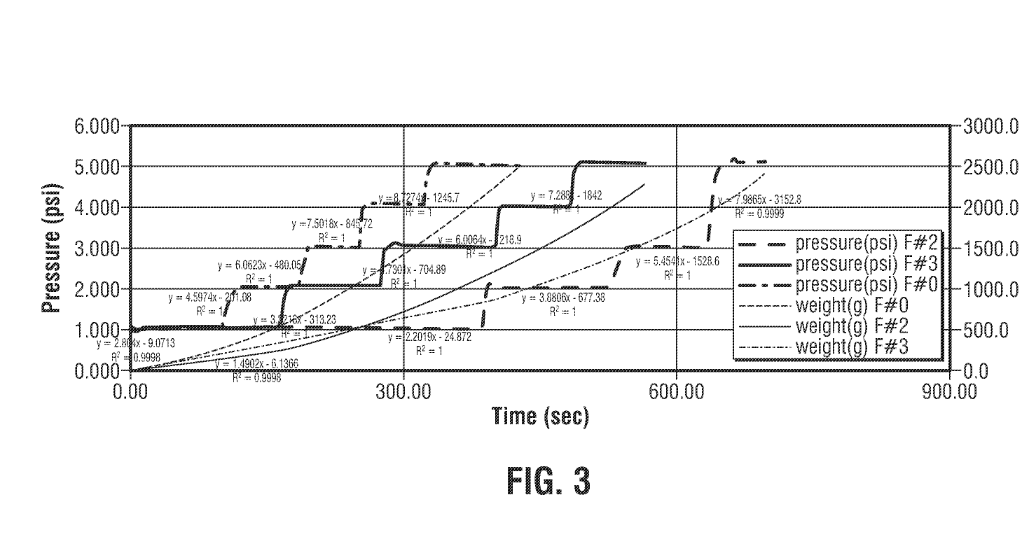

After each test, the now spent breaker was carefully removed from the HTHP cell and the pH was measured (Table 5). Next LVT-200 was used to refill the cell before simulating flow as production. This was performed using arbitrary pressures from 1 thru 5 psi. The graphs shown in FIGS. 2 thru 3 include these pressures as well as the mass rate recorded over time. The F0 through F3 designate the breaker system. The slope at each pressure should be compared as this represents the difference in flow between the selected breaker systems. The increasing rates are also a means to assess if solids are plugging the pores, gravel, even the screen coupon. For these tests no decrease in rate was apparent. FIG. 2 shows return flow with and without the RDF filter cake. The gravel is most likely a barrier in addition to the residual filtercake which yields the relatively low percent return to flow, approximately 8.7%. FIG. 3 shows return flow to flow using breakers 2 and 3 after 7 days soak. A comparison of Formulation #2 (30% D-Structor+2.5% D-SOVLVER HD) and Formulation #3 (2.5% D-Structor+30% D-Sovlver HD) show that both systems resulted in a low flow initiation pressure, less than 1 psi.

The final return to flow as a percentage is compared relative to the control where the flow without filtercake in the cell was measured (FIGS. 2-3). There are two references in this matrix. Every combination of breaker system and DIPRO filtercake were compared to the corresponding control. Table 5 summarizes the mass rate or slope for each pressure/period, which respectively is proportional to the volume rate and the differential pressure applied. The pH measurements are included. Typically pH increases towards alkaline as the breaker reacts with the residual filtercake components.

TABLE 5
Mass Rate or Calculated Slope for Each Breaker System

| Sand Type: | 20/40 Gravel | 20/40 Gravel | 20/40 Gravel | 20/40 Gravel |
|---|---|---|---|---|
| Completion | Post-Spot | Post-Spot | Post-Spot | Post-Spot |
| Filter cake | Yes | No | Yes | Yes |
| | | | 30% D- | 2.5% D- |
| | | | Structor + | Structor + |
| | No Treatment | | 2.5% D- | 30% D- |
| | (Control) | Reference 1 | Sovlver HD | Sovlver HD |
| Pressure | Formulation | for 20/40 | Formulation | Formulation |
| (psia) | #1 | Gravel | #2 | #3 |
| 1 | 0 | 2.804 | 2.2019 | 1.4902 |
| 2 | 0.0206 | 4.5974 | 3.8806 | 3.3218 |
| 3 | 0.4227 | 6.0623 | 5.4541 | 4.7301 |
| 4 | 1.1204 | 7.5018 | | 6.0064 |
| 5 | 1.8643 | 8.7274 | 7.9865 | 7.2880 |
| pH (cell) | 7.3 | | 2.65 | 3.25 |
| pH (filtrate) | 6.9 | | 3.6 | 3.74 |

Using the references and these slopes of each breaker system for each pressure applied, the percent return flow was calculated and summarized in Table 6.

TABLE 6
Percent Return Flow as Compared
with the Corresponding Reference.

| | Return to Flow (%) | | |
|---|---|---|---|
| Pressure (psi) | Formulation #1 | Formulation #2 | Formulation #3 |
| 1 | 0.00% | 78.53% | 53.15% |
| 2 | 0.45% | 84.41% | 72.25% |
| 3 | 6.97% | 89.97% | 78.02% |
| 4 | 14.94% | 89.00%¹ | 80.07% |
| 5 | 21.36% | 91.51% | 83.51% |
| Average | 8.74% | 86.68% | 73.40% |

¹Estimate value based on linear equation adjustment from Table 1.

Formulation 0, where the filter cake was not removed, exhibited 21.4% of return flow at 5 psi. This relatively low value most likely reflects only partial hydraulic wash-out of the residual filtercake. Note that flow was not initiated until approximately 3 psi. Formulation 2 exhibited 91.5% return flow at the same pressure. This is most likely due to its relatively high ester/acid strength. Formulation 3 exhibited 83.5% return flow and the residual starch is most likely mitigating the flow rate needed to attain the same percent return as tests/formulations 2.

In sum, Formulation 2 is formulated for post-completion use. After 7 days exposure the gravel exhibited a relatively clean aspect (based on visual detection) and approximately 91.5% return of initial flow was realized with 5 psi. This breaker's density was achieved using the two-salt 13.0 lb./gal. CaCl₂/CaBr₂. Formulation 3 is formulated for post-completion use and to alleviate corrosion potential and promote delay. The primary mechanism is a chelant, D-SOVLVER HD, which functions in divalent brines. While residual starch was present after the seven day soak (based on visual detection) the percent return of initial flow in production, approximately 84%, was realized using 5 psi.

Although the preceding description has been described herein with reference to particular means, materials, and embodiments, it is not intended to be limited to the particulars disclosed herein; rather, it extends to all functionally equivalent structures, methods and uses, such as are within the scope of the appended claims.

What is claimed:

1. A method comprising:
circulating a breaker fluid into a wellbore, the breaker fluid comprising:
a base fluid of divalent brine having an amount of free water therein;
a primary breaker; and
a secondary breaker present in an amount less than the primary breaker,
where the primary breaker is either a hydrolysable ester of a carboxylic acid or an iminodiacetic acid, and the secondary breaker is the other of the hydrolysable ester of a carboxylic acid or an iminodiacetic acid.

2. The method of claim 1, wherein the hydrolysable ester is the primary breaker and present in an amount ranging from 10 to 50 volume percent, and the iminodiacetic acid is the secondary breaker and present in an amount up to 10 volume percent.

3. The method of claim 1, wherein the iminodiacetic acid is the primary breaker and present in an amount ranging from 10 to 40 volume percent, and the hydrolysable ester is the secondary breaker and present in an amount up to 10 volume percent.

4. The method of claim 1, wherein the free water content is at least 15 volume percent.

5. The method of claim 1, wherein the free water content is at least 20 volume percent.

6. The method of claim 1, wherein the free water content is at least 25 volume percent.

7. A method comprising:
circulating a breaker fluid into a wellbore, the breaker fluid comprising:
a base fluid of divalent brine;
a hydrolysable ester of a carboxylic acid in an amount ranging from 10 to 50 volume percent; and
an iminodiacetic acid in an amount ranging up to 10 volume percent,
wherein the breaker fluid has a free water content of at least 25 volume percent.

8. The method of claim 7, wherein the hydrolysable ester is present in an amount ranging from 20 to 40 volume percent.

9. A method comprising:
circulating a breaker fluid into a wellbore, the breaker fluid comprising:
a base fluid of divalent brine;
an acid precursor in an amount ranging up to 10 volume percent; and
an iminodiacetic acid in an amount ranging from 10 to 40 volume percent,
wherein the breaker fluid has a free water content of at least 25 volume percent.

10. The method of claim 9, wherein the iminodiacetic acid is present in an amount ranging from 15 to 35 volume percent.
